(19) United States
(12) Patent Application Publication
(10) Pub. No.: US 2001/0050464 A1
(43) Pub. Date: Dec. 13, 2001

(54) Housing seal

(76) Inventors: Satoru Kuramoto, Kariya-shi (JP); Takeshi Yamada, Kariya-shi (JP)

Correspondence Address: MORGAN & FINNEGAN, L.L.P., 345 Park Avenue, New York, NY, 10154, US

(21) Appl. No.: 09/867,866

(22) Filed: May 30, 2001

(30) Foreign Application Priority Data
Jun. 9, 2000 (JP) 2000-173275

(51) Int. Cl. F16J 15/02

(52) U.S. Cl. 277/637

(57) ABSTRACT

An improved housing seal. Resin is applied to the outer surface of a joint between adjacent housing members. This produces an effective, simple in structure, and inexpensive seal that limits the size of the housing.

### BACKGROUND OF THE INVENTION

The present invention relates to a seal for sealing a housing.

A typical compressor of an air conditioner includes a housing having a plurality of housing members joined to each other with bolts or the like. A sealing member is provided between each two adjacent housing members for preventing gas from leaking.

Japanese Unexamined Patent Publications Nos. Hei 8-261150,Hei 9-42156 and others disclose multi-sealing mechanisms which have a plurality of sealing members arranged between two adjacent housing members. The sealing members are made of rubber.

Japanese Unexamined Utility Model Registration Publication No. Sho 57-156085 discloses a sealing mechanism for housing members, each of which is applied with a rubber coating substantially over the entire surface thereof.

In recent years, the use of carbon dioxide as a refrigerant for air conditioners has been proposed in consideration of environmental problems. However, carbon dioxide easily penetrates a rubber material. For this reason, sealing members made of rubber cannot adequately prevent the gas from leaking.

This problem may be solved by using a rubber material that is resistant to heat and oil, less prone to the formation of blisters, and less penetrable to gases. However, such a rubber material is expensive.

Furthermore, a multiple sealing structure or thicker rubber sealing members, intended to improve the seal, will require the parts of the housing members corresponding to the sealing members to be larger, which increases the size of the housing. Also, when carbon dioxide is used as a refrigerant, gas leakage cannot be adequately prevented.

### BRIEF SUMMARY OF THE INVENTION

It is an object of the present invention to provide a sealing mechanism that forms a superior seal is simple in structure, inexpensive, and capable of reducing the size of the housing.

To achieve the above object, the present invention provides a sealing mechanism for sealing a housing. The housing has two adjacent housing members. The housing members are connected with each other. Resin is applied to the outer surface of a joint between the housing members.

Other aspects and advantages of the invention will become apparent from the following description, taken in conjunction with the accompanying drawings, illustrating by way of example the principles of the invention.

### BRIEF DESCRIPTION OF THE SEVERAL VIEWS OF THE DRAWINGS

The invention, together with objects and advantages thereof, may best be understood by reference to the following description of the presently preferred embodiments together with the accompanying drawings in which:

FIG. 1 is a cross-sectional view illustrating a compressor of a first embodiment of the present invention;

FIG. 2 (a) is an enlarged cross-sectional view illustrating the seal between a front housing member and a cylinder block of FIG. 1;

FIG. 2 (b) is an enlarged cross-sectional view illustrating the seal between the cylinder block and the rear housing member of FIG. 1;

FIG. 3 (a) is an enlarged cross-sectional view like that in FIG. 2 of a second embodiment;

FIG. 3 (b) is an enlarged cross-sectional view like that in FIG. 2 of a third embodiment;

FIG. 3 (c) is an enlarged cross-sectional view like that in FIG. 2 of a fourth embodiment;

FIG. 3 (d) is an enlarged cross-sectional view like that in FIG. 2 of a fifth embodiment; and

FIG. 3 (e) is an enlarged cross-sectional view like that in FIG. 2 of a sixth embodiment.

### DETAILED DESCRIPTION OF THE PREFERRED EMBODIMENTS

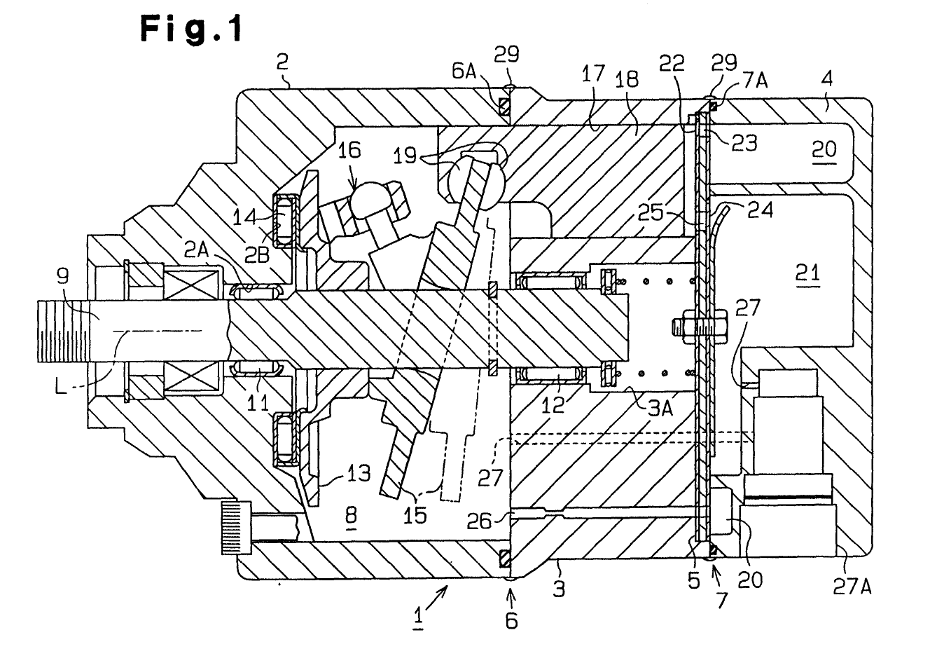

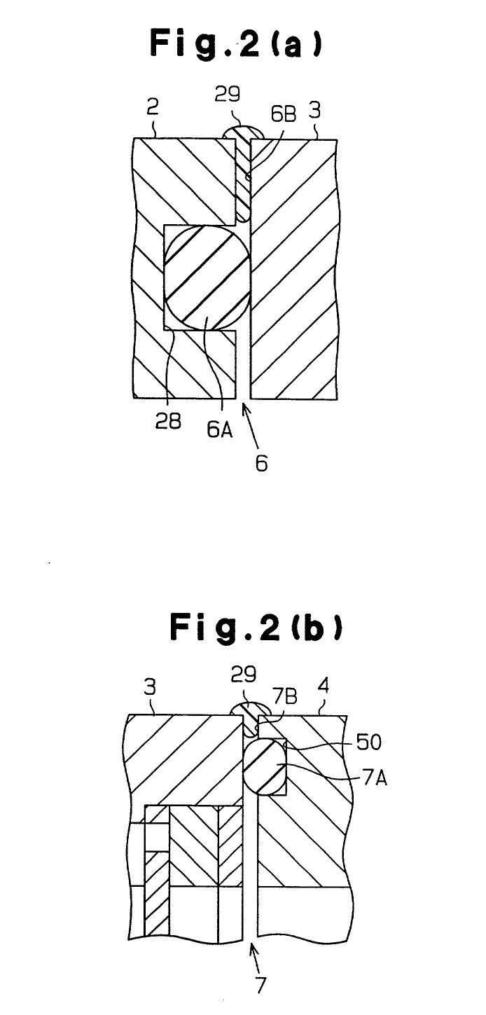

In the following, a first embodiment of the present invention, which is a sealing mechanism for a compressor for use in an air conditioner, will be described with reference to FIGS. 1 and 2.

As illustrated in FIG. 1, a compressor 1 is a variable capacity type compressor. Carbon dioxide is used as a refrigerant in the compressor 1. A metal front housing member 2 is joined to the front end of a metal cylinder block 3. A metal rear housing member 4 is joined to the rear end of the cylinder block 3. A valve plate assembly 5 is located between the cylinder block 3 and the rear housing member 4. The valve plate assembly 5 is fitted in a recess formed on the rear end of the cylinder block 3. A crank chamber 8 is formed between the front housing member 2 and the cylinder block 3. The front housing member 2, cylinder block 3 and rear housing member 3 form a housing.

A rotating shaft 9 is supported by the front housing member 2 and the cylinder block 3 to extend through the crank chamber 8. A pair of radial bearings 11, 12 for supporting the rotating shaft 9 are fitted in a through hole 2A formed through the front housing member 2 and a through hole 3A formed through the cylinder block 3, respectively. The front end of the rotating shaft 9 is coupled to an external driving source, not shown.

A rotation supporting member 13 is accommodated in the crank chamber 8 and fixed to the rotating shaft 9. A thrust bearing 14 is located between the rotation supporting member 13 and an inner wall surface 2B of the front housing member 2. A swash plate 15 is accommodated in the crank chamber 8 and supported on the rotating shaft 9. The swash plate 15 moves along the surface of the rotating shaft 9 and inclines. A hinge mechanism 16 is located between the rotation supporting member 13 and the swash plate 15. The hinge mechanism 16 allows the swash plate 15 to incline move with respect to the rotating shaft 9 and causes the swash plate 15 to integrally rotate together with the rotating shaft 9. As the swash plate 15 moves toward the cylinder block 3, the inclination angle of the swash plate 15 decreases. As the swash plate 15 moves toward the rotation supporting member 13, the inclination angle of the swash plate 15 increases.

A plurality of cylinder bores 17 (only one of which is shown in FIG. 1) is formed through the cylinder block 3. A single headed piston 18 is accommodated in each cylinder bore 17. Each piston 18 is coupled to the outer periphery of the swash plate 15 through a pair of shoes 19. When the swash plate 15 rotates, each piston 18 reciprocates within the corresponding cylinder bore 17.

A suction chamber 20 and a discharge chamber 21 are separately defined in the rear housing member 4. A suction valve 22, a suction port 23, a discharge valve 24 and a discharge port 25, corresponding to each cylinder bore 17, are formed in a valve plate assembly 5. When the piston 18 is moved from a top dead center position to a bottom dead center position, a refrigerant within the suction chamber 20 flows into the cylinder bore 17 through the suction port 23 and the suction valve 22. When the piston 18 is moved from the bottom dead center to the top dead center, the refrigerant gas within the cylinder bore 17 flows into the discharge chamber 21 through the discharge port 25 and the discharge valve 24 after it is compressed to a predetermined pressure.

A bleed passage 26 having a restriction communicates the crank chamber 8 with the suction chamber 20. The refrigerant within the crank chamber 8 flows out to the suction chamber 20 through the bleed passage 26. The discharge chamber 21 is communicated with the crank chamber 8 through a suction passage 27. A control valve 27A is arranged in the suction passage 27. The control valve 27A controls the flow rate of the refrigerant supplied from the discharge chamber 21 to the crank chamber 8. The pressure within the crank chamber 8 is determined by the flow rate of the refrigerant flowing from the crank chamber 8 to the suction chamber 20 through the bleed passage 26 and the flow rate of the refrigerant flowing from the discharge chamber 21 into the crank chamber 8 through the control valve 27A. The inclination angle of the swash plate 15 is adjusted by varying the pressure within the crank chamber 8 to change the stroke of the piston 18 and the discharge capacity of the compressor.

As illustrated in FIG. 2 (a), a first seal ring 6A is fitted in a groove 28 formed in the front housing member 2, which is joined with the cylinder block 3. The opening of the groove 28 is covered with the cylinder block 3.

A slight gap 6B is formed between the front housing member 2 and the cylinder block 3 for possible dimensional errors in the front housing member 2 and the cylinder block 3 and for reasons of an intended design. A resin 29 adheres to a joint 6 between the front housing member 2 and the cylinder block 3 for filling the gap 6B. Some of the resin 29 enters the gap 6B The remainder of the resin 29 swells from the front housing member 2 and the cylinder block 3 as illustrated.

As illustrated in FIG. 2 (b), a second seal ring 7A is fitted in a groove 50 formed in the rear housing member 4, which is joined with the cylinder block 3. The opening of the groove 50 is covered with the cylinder block 3.

A slight gap 7B is formed between the cylinder block 3 and the rear housing member 4 for dimensional errors of the cylinder block 3 and the rear housing member 4 and for reasons of an intended design. A resin 29 adheres to a joint 7 between the cylinder block 3 and the rear housing member 4 for filling the gap 7B. Some of the resin 29 enters the gap 7B. The remainder of the resin 29 swells from the cylinder block 3 and the rear housing member 4 as shown. The resin 29 should be such one that resists penetration by carbon dioxide. Preferably, nylon 66 or high acrylonitrile containing polymer resin, for example, may be used for the resin 29.

In the foregoing embodiment, the following advantages are provided.

The resin 29 adhering to the joints 6, 7 fills the gaps 6B, 7B. Since the resin 29 resists penetration by carbon dioxide, the carbon dioxide is prevented from leaking from the compressor 1.

Since the resin 29 forms a good seal, only one of the seal rings 6A, 7A, which have a relatively small cross sections, is required for each joint 6, 7. This results in a simple structure of both joints 6, 7 and a smaller size of the compressor 1.

The resin 29 is chosen to resist penetration by gas. Therefore, both ring seals 6, 7 may be formed of a material that is highly penetrable to a gas. For example, it is possible to select nitrile rubber as the material of both seal rings 6A, 7A. Nitrile rubber is resistant to heat and oil, less prone to the formation of blisters, and inexpensive. This reduces the cost of the seal rings 6A, 7A.

The resin 29 is applied to the joints 6, 7 from the outside of the compressor 1. Therefore, the operation of installing the seal is relatively simple which lowers costs.

The foregoing embodiment may be modified, for example, in the following manner.

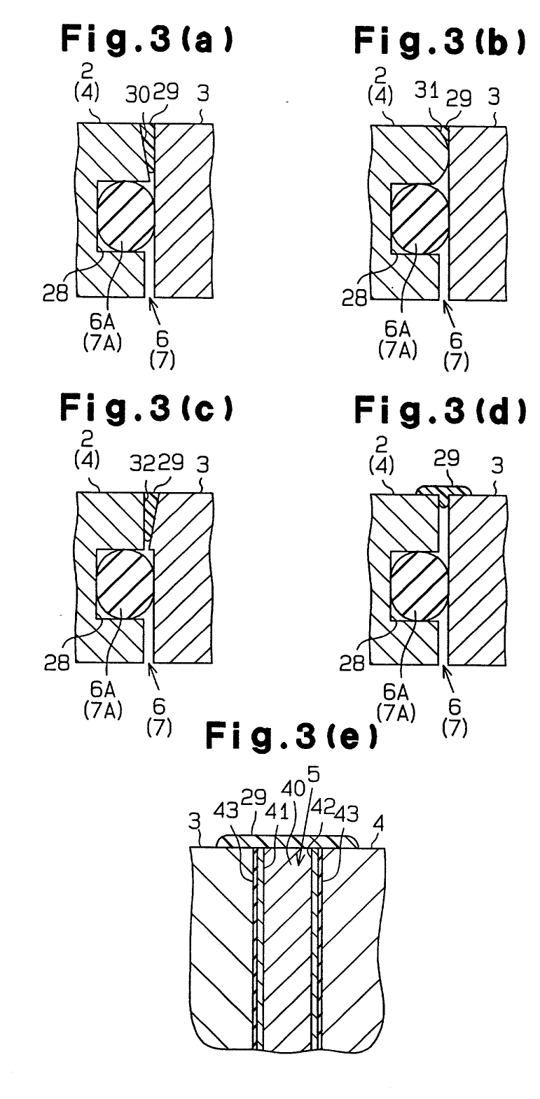

As can be seen in a second embodiment illustrated in FIG. 3 (a), a third embodiment in FIG. 3 (b), and a fourth embodiment in FIG. 3 (c), a portion of the joint 6 may be formed as a cavity 30, 31 or 32, which is filled by the resin 29. The joint 7 may be formed in a manner similar to the joint 6. In this way, the resin 29 can be introduced securely between the cylinder block 3 and the front housing member 2 or between the cylinder block 3 and the rear housing member 4. This improves the seal and the efficiency of the application of the resin 29.

In the embodiments illustrated in FIGS. 3 (a) and 3 (c), the cavities 30, 32 diverge toward the outside of the compressor 1. This shape facilitates the application of the resin 29 into the corresponding cavities 30, 32.

In the structure illustrated in FIG. 3 (b), at the outside of the respective seal rings 6A, 7A in the radial direction, the cylinder block 3 abuts against the front housing member 2, and the cylinder block 3 abuts against the rear housing member 4, and a filler 31 is formed outside of the abutment in the radial direction. In this structure, the joints 6, 7 are sealed by the contact between the cylinder block 3 and the front housing member 2 and the contact between the cylinder block 3 and the rear housing member 4 and by the seal rings 6A, 7A and the resin 29. Thus, the seals are further improved.

As can be seen in a fifth embodiment illustrated in FIG. 3 (d), the resin 29 may hardly enter the joints 6, 7. A majority of the resin 29 remains on the surface of the housing. In this embodiment, the resin 29 can be applied by spraying, to improve efficiency.

In a sixth embodiment illustrated in FIG. 3 (e), the valve plate assembly 5 has the same diameter as that of the housing. The valve plate assembly 5 includes a main plate 40, which includes suction ports 23 and discharge ports 25, a first subplate 41, which includes suction valves 22, and a second subplate 42, which includes discharge valves 24. The valve plate assembly 5 is sandwiched by two gaskets 43 made of rubber. One gasket 43 is located between the cylinder block 3 and the first subplate 41, and the other gasket 43 is located between the rear housing member 4 and the second subplate 42. The resin 29 is applied to cover the joints on the surface of the housing of the compressor. Refrigerant gas is prevented from leaking to the outside of the compressor 1 by the resin 29.

In the embodiment of FIG. 3 (e), the resin 29 need not radially enter a gap between adjacent parts. In this way, the resin 29 can be applied by spraying from the outside, thereby improving efficiency.

The refrigerant gas may be, for example, freon gas. In this case, the preferred resin 29 is one that resists penetration by freon gas.

The present invention is not limited to housings of compressors and may be applied to the housings of any equipment.

Therefore, the present examples and embodiments are to be considered as illustrative and not restrictive and the invention is not to be limited to the details given herein, but may be modified within the scope and equivalence of the applied claims.

1. A sealing mechanism for sealing a housing, wherein the housing has two adjacent housing members, wherein the housing members are connected with each other, wherein resin is applied to the outer surface of a joint between the housing members.

2. The sealing mechanism according to claim 1, wherein a cavity is formed between the adjacent housing members and is filled by the resin.

3. The sealing mechanism according to claim 2, wherein the cavity is tapered.

4. The sealing mechanism according to claim 1, wherein the resin is mainly applied to the surface of the housing.

5. The sealing mechanism according to claim 1, wherein the resin resists penetration by carbon dioxide.

6. The sealing mechanism according to claim 1, wherein the housing is a housing of a compressor that compresses refrigerant.

7. A sealing mechanism for sealing a housing, wherein an inner portion of the housing is under a relatively high pressure, wherein the housing has two adjacent housing members, and the housing members are connected with each other, wherein resin is applied to a joint between the housing members, wherein the resin resists penetration by gasses.

8. The sealing mechanism according to claim 7, wherein a cavity is formed between the adjacent housing members and is filled by the resin.

9. The sealing mechanism according to claim 8, wherein the cavity is tapered.

10. The sealing mechanism according to claim 7, wherein the resin is mainly applied to the surface of the housing.

11. The sealing mechanism according to claim 7, wherein the resin resists penetration by carbon dioxide.

12. The sealing mechanism according to claim 7, wherein the housing is a housing of a compressor that compresses a refrigerant.
